(19) United States
(12) Patent Application Publication
(10) Pub. No.: US 2004/0009336 A1
(43) Pub. Date: Jan. 15, 2004

(54) Titanium silicon nitride (TISIN) barrier layer for copper diffusion

(75) Inventors: Christophe Marcadal, Sunnyvale, CA (US); Ling Chen, Sunnyvale, CA (US)

Correspondence Address: Patent Counsel, APPLIED MATERIALS, INC., P. O. Box 450-A, Santa Clara, CA, 95052, US

(73) Assignee: Applied Materials, Inc.

(21) Appl. No.: 10/194,808

(22) Filed: Jul. 11, 2002

(51) Int. Cl. B32B 9/00

(52) U.S. Cl. 428/210; 428/698; 428/699; 428/472

(57) ABSTRACT

Methods and an apparatus of forming a titanium silicon nitride (TiSiN) layer are disclosed. The titanium silicon nitride (TiSiN) layer may be formed using a cyclical deposition process by alternately adsorbing a titanium-containing precursor, a silicon-containing gas and a nitrogen-containing gas on a substrate. The titanium-containing precursor, the silicon-containing gas and the nitrogen-containing gas react to form the titanium silicon nitride (TiSiN) layer on the substrate. The formation of the titanium silicon nitride (TiSiN) layer is compatible with integrated circuit fabrication processes. In one integrated circuit fabrication process, a titanium silicon nitride (TiSiN) layer may be used as a diffusion barrier for a copper metallization process.

### BACKGROUND OF THE INVENTION

1. Field of the Invention

Embodiments of the present invention generally relate to an apparatus and method for depositing a titanium silicon nitride layer. More particularly, embodiments of the present invention relate to an apparatus and method of depositing a titanium silicon nitride layer using a cyclical deposition.

2. Description of the Related Art

Reliably producing sub-micron and smaller features is one of the key technologies for the next generation of very large scale integration (VLSI) and ultra large scale integration (ULSI) of semiconductor devices. However, as the fringes of circuit technology are pressed, the shrinking dimensions of interconnects in VLSI and ULSI technology have placed additional demands on the processing capabilities. The multilevel interconnects that lie at the heart of this technology require precise processing of high aspect ratio features, such as vias and other interconnects. Reliable formation of these interconnects is very important to VLSI and ULSI success and to the continued effort to increase circuit density and quality of individual substrates.

As circuit densities increase, the widths of interconnects, such as vias, trenches; contacts, and other features, as well as the dielectric materials between them, decrease to sub-micron dimensions (e.g., less than 0.20 micrometers or less), whereas the thickness of the dielectric layers remains substantially constant, with the result that the aspect ratios for the features, i.e., their height divided by width, increase. Many traditional deposition processes have difficulty filling sub-micron structures where the aspect ratio exceeds 4:1. Therefore, there is a great amount of ongoing effort being directed at the formation of substantially void-free and seam-free sub-micron features having high aspect ratios.

Currently, copper and its alloys have become the metals of choice for sub-micron interconnect technology because copper has a lower resistivity than aluminum, (1.7 μΩ-cm compared to 3.1 μΩ-cm for aluminum), and a higher current carrying capacity and significantly higher electromigration resistance. These characteristics are important for supporting the higher current densities experienced at high levels of integration and increased device speed. Further, copper has a good thermal conductivity and is available in a highly pure state.

However, one problem with the use of copper is that copper diffuses into silicon, silicon dioxide, and other dielectric materials, which may compromise the integrity of devices. Therefore, conformal barrier layers become increasingly important to prevent copper diffusion. Titanium silicon nitride (TiSiN) is one material being explored for use as a barrier material to prevent the diffusion of copper into underlying layers. One problem with prior titanium silicon nitride barrier layers is that the silicon in titanium silicon nitride may react with the copper to form copper silicide, which has a high resistance and, thus, increases the resistance of the interconnect.

Therefore, there is a need for an improved barrier layer for use in metallization of interconnects.

### SUMMARY OF THE INVENTION

The present invention relates to methods and an apparatus of forming a titanium silicon nitride (TiSiN) layer. The titanium silicon nitride (TiSiN) layer may be formed using a cyclical deposition process by alternately adsorbing a titanium-containing precursor, a silicon-containing gas and a nitrogen-containing gas on a substrate. The titanium-containing precursor, the silicon-containing gas and the nitrogen-containing gas react to form the titanium silicon nitride (TiSiN) layer on the substrate.

The formation of the titanium silicon nitride (TiSiN) layer is compatible with integrated circuit fabrication processes. In one integrated circuit fabrication process, a titanium silicon nitride (TiSiN) layer may be used as a diffusion barrier for a copper metallization process. For such an embodiment, a preferred process sequence includes forming a titanium silicon nitride (TiSiN) layer in apertures defined in a dielectric material layer formed on a substrate. The titanium silicon nitride (TiSiN) layer is formed by alternately adsorbing a titanium-containing precursor, a silicon-containing gas and a nitrogen-containing gas in the apertures. Thereafter, the copper metallization process is completed by filling the apertures with copper (Cu).

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a schematic cross-sectional view of a process chamber that can be used for the practice of embodiments described herein;

FIG. 2 illustrates a process sequence for the formation of a titanium silicon nitride (TiSiN) layer using cyclical deposition techniques according to one embodiment described herein;

FIGS. 3A-3C illustrate several other exemplary process sequences for the formation of a titanium silicon nitride (TiSiN) layer using cyclical deposition techniques;

FIG. 4 is a graph of the TiSiN resistivity plotted as a function of the silicon-containing gas pulse time; and

FIGS. 5A-5C depict cross-sectional views of a substrate at different stages of a copper metallization sequence.

### DETAILED DESCRIPTION

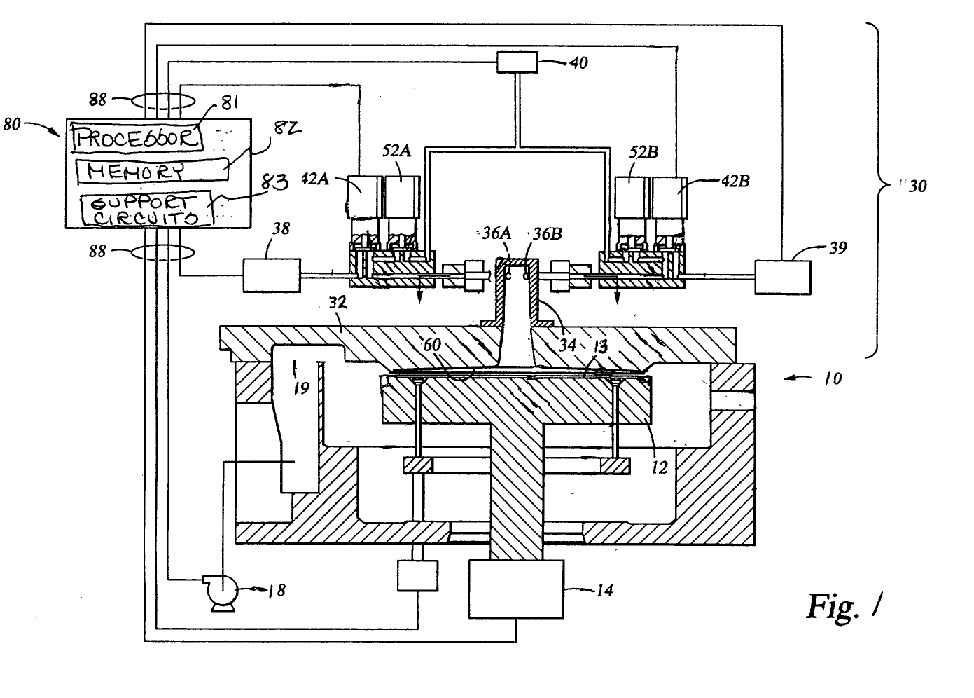

FIG. 1 depicts a schematic cross-sectional view of a process chamber 10 that can be used for the practice of embodiments described herein. The process chamber 10 includes a wafer support pedestal 12, which is used to support a substrate 13 within the process chamber 10. The wafer support pedestal 12 is movable in a vertical direction inside the process chamber 10 using a displacement mechanism 14. The wafer support pedestal may also include a vacuum chuck (not shown), an electrostatic chuck (not shown), or a clamp ring (not shown) for securing the substrate 13 thereto during a deposition sequence.

Depending on the specific deposition process, the substrate 13 may be heated to some desired temperature prior to or during deposition. For example, the wafer support pedestal 12 may be heated using an embedded heater element (not shown). The wafer support pedestal 12 may be resistively heated by applying an electric current from an AC power supply (not shown) to the heater element (not shown). The substrate 13 is, in turn, heated by the wafer support pedestal 12. Alternatively, the wafer support pedestal 12 may be heated using radiant heaters such as, for example, lamps (not shown).

A vacuum pump 18, in communication with a pumping channel 19, is used to evacuate the process chamber 10 and to maintain the pressure inside the process chamber 10. A gas delivery system 30 is disposed on an upper portion of the process chamber 10. The gas delivery system 30 provides process gases to the process chamber 10.

The gas delivery system 30 may comprise a chamber lid 32. The chamber lid 32 includes an expanding channel 34 extending from a central portion of the chamber lid 32 as well as a bottom surface 60 extending from the expanding channel 34 to a peripheral portion of the chamber lid 32. The bottom surface 60 of the chamber lid 32 is sized and shaped to substantially cover the substrate 13 disposed on the wafer support pedestal 12. The expanding channel 34 also includes gas inlets 36A, 36B through which gases are provided to the process chamber 10.

The gas inlets 36A, 36B are coupled to gas valves 42A, 42B, 52A, 52B. Gas valves 42A, 42B may be coupled to process gas sources 38, 39, respectively, while gas valves 52A, 52B may be coupled to a gas source 40. The gas valves 42A, 42B, 52A, 52B as used herein refer to any gas valve capable of providing rapid and precise gas flow to the process chamber 10 with valve open and close cycles of less than about 1-2 seconds, and more preferably less than about 0.5 seconds. Suitable gas valves may include for example, electronic control valves and pneumatic valves, among others. Proper control and regulation of gas flows to the gas delivery system 30 are performed by a microprocessor controller 80.

The microprocessor controller 80 may be one of any form of general purpose computer processor (CPU) 81 that can be used in an industrial setting for controlling various chambers and sub-processors. The computer may use any suitable memory 82, such as random access memory, read only memory, floppy disk drive, hard disk, or any other form of digital storage, local or remote. Various support circuits 83 may be coupled to the CPU for supporting the processor in a conventional manner. Software routines as required may be stored in the memory or executed by a second CPU (not shown) that is remotely located.

The software routines are executed to initiate process recipes or sequences. The software routines, when executed, transform the general purpose computer into a specific process computer that controls the chamber operation so that a chamber process is performed. For example, software routines may be used to precisely control the activation of the gas valve for the execution of process sequences according to embodiments described herein. Alternatively, the software routines may be performed in hardware, as an application specific integrated circuit or other type of hardware implementation, or a combination of software and hardware.

Titanium Silicon Nitride Layer Formation

Methods of titanium silicon nitride (TiSiN) layer formation are described. The titanium silicon nitride (TiSiN) layer is formed using a cyclical deposition process by alternately adsorbing a titanium-containing precursor, a silicon-containing gas and a nitrogen-containing gas on a substrate. The cyclical deposition techniques employed for the titanium silicon nitride (TiSiN) layer formation provide diffusion barriers for copper.

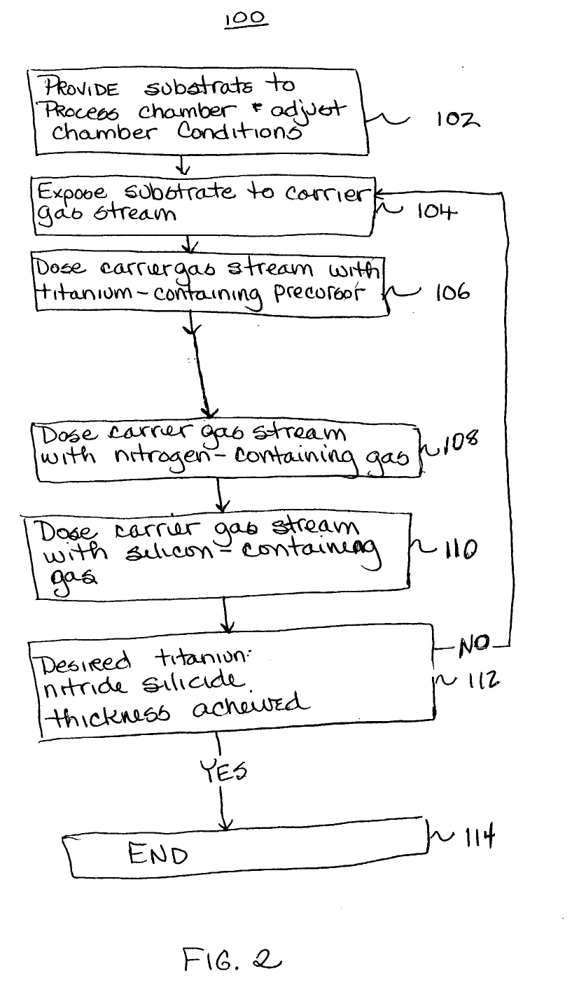

FIG. 2 illustrates one embodiment of a process sequence 100 for titanium silicon nitride (TiSiN) layer formation utilizing a constant carrier gas flow. These steps may be performed in a process chamber similar to that described above with reference to FIG. 1. As shown in step 102, a substrate is provided to the process chamber. The substrate may be for example, a silicon substrate ready for a copper metallization process sequence. The process chamber conditions, such as, for example, the temperature and pressure are adjusted to enhance the adsorption of process gases on the substrate. In general, for titanium silicon nitride (TiSiN) layer deposition, the substrate should be maintained at a temperature below about 350° C. at a process chamber pressure of less than about 20 torr.

In one embodiment where a constant carrier gas flow is desired, a carrier gas stream is established within the process chamber as indicated in step 104. Carrier gases may be selected so as to also act as a purge gas for removal of volatile reactants and/or by-products from the process chamber. Carrier gases such as, for example, helium (He), argon (Ar) and nitrogen (N₂), as well as combinations thereof, among others may be used.

Referring to step 106, after the carrier gas stream is established within the process chamber, a pulse of a titanium-containing precursor is added to the carrier gas stream. The term pulse as used herein refers to a dose of material injected into the process chamber or into the constant carrier gas stream. The pulse of the titanium-containing precursor lasts for a predetermined time interval. Suitable titanium-containing precursors may include for example, tetrakis(dimethylamido) titanium (TDMAT) and tetrakis(diethylamido) titanium (TDEAT), among others.

The time interval for the pulse of the titanium-containing precursor is variable depending upon a number of factors such as, for example, the volume capacity of the process chamber employed, the vacuum system coupled thereto and the volatility/reactivity of the reactants used. For example, (1) a large-volume process chamber may lead to a longer time to stabilize the process conditions such as, for example, carrier/purge gas flow and temperature, requiring a longer pulse time; and (2) a lower flow rate for the process gas may also lead to a longer time to stabilize the process conditions requiring a longer pulse time. In general, the process conditions are advantageously selected so that a pulse of the titanium-containing precursor provides a sufficient amount of precursor, such that at least a monolayer of the titanium-containing precursor is adsorbed on the substrate. Thereafter, excess titanium-containing precursor remaining in the chamber may be removed from the process chamber by the constant carrier gas stream in combination with the vacuum system.

In step 108, after the excess titanium-containing precursor has been sufficiently removed from the process chamber by the constant carrier gas stream to prevent co-reaction or particle formation with a subsequently provided process gas, a pulse of a nitrogen-containing gas is added to the carrier gas stream. Suitable nitrogen-containing gases may include, for example, ammonia (NH₃), hydrazine (N₂H₄), monomethyl hydrazine (CH₃N₂H₃), dimethyl hydrazine (C₂H₆N₂H₂), t-butyl hydrazine (C₄H₉N₂H₃), phenyl hydrazine (C₆H₅N₂H₃), 2,2′-azoisobutane ((CH₃)₆C₂N₂) and ethylazide (C₂H₅N₃), among others.

The pulse of the nitrogen-containing gas lasts for a predetermined time interval that is variable. In general, the time interval for the pulse of the nitrogen-containing gas should be long enough for adsorption of at least a monolayer of the nitrogen-containing gas on the tantalum-containing precursor. Thereafter, excess nitrogen-containing gas remaining in the chamber may be removed therefrom by the constant carrier gas stream in combination with the vacuum system.

As indicated in step 110, after the excess nitrogen-containing gas has been sufficiently removed from the process chamber by the constant carrier gas stream to prevent co-reaction or particle formation with a subsequently provided process gas, a pulse of a silicon-containing gas is added to the carrier gas stream. Suitable silicon-containing gases may include, for example, silane (SiH₄), disilane (Si₂H₆), chlorosilane (SiH₃Cl), dichlorosilane (SiH₂Cl₂), silicon tetrachloride (SiCl₄), hexachlorodisilane (Si₂Cl₆), trichlorosilane (SiHCl₃) and methyl silane (SiCH₆) among others.

The pulse of the silicon-containing gas lasts for a predetermined time interval that is variable. In general, the time interval for the pulse of the silicon-containing gas should be long enough for adsorption of at least a monolayer of the silicon-containing gas on the nitrogen-containing monolayer. Thereafter, excess silicon-containing gas remaining in the chamber may be removed therefrom by the constant carrier gas stream in combination with the vacuum system.

Steps 104 through 110 comprise one embodiment of a deposition cycle for the ternary nitride layer. For such an embodiment, a constant flow of the carrier gas is provided to the process chamber modulated by alternating periods of pulsing and non-pulsing where the periods of pulsing alternate between the titanium-containing precursor, the nitrogen-containing gas and the silicon-containing gas along with the carrier gas stream, while the periods of non-pulsing include only the carrier gas stream.

The time interval for each of the pulses of the titanium-containing precursor, the nitrogen-containing gas and the silicon-containing gas may have the same duration. That is, the duration of the pulses of the titanium-containing precursor may be identical to the duration of each of the pulses the nitrogen-containing gas and the silicon-containing gas. For such an embodiment, a time interval (T₁) for the pulse of the titanium-containing precursor equals a time interval (T₂) for the pulse of the nitrogen-containing gas and a time interval (T₃) for the pulse of the silicon-containing gas.

Alternatively, the time interval for at least one of the pulses of the titanium-containing precursor, the nitrogen-containing gas and the silicon-containing gas may have different durations. That is, the duration of the pulse of the titanium-containing precursor may be shorter or longer than the duration of one of the pulse of the nitrogen-containing gas or the pulse of the silicon-containing gas. For such an embodiment, the time interval (T₁) for the pulse of the titanium-containing precursor is different than the time interval (T₂) for the pulse of the nitrogen-containing gas or the time interval (T₃) for the pulse of the silicon-containing gas.

In addition, the periods of non-pulsing after each of the pulses of the titanium-containing precursor, the nitrogen-containing gas and the silicon-containing gas may have the same duration. That is, the duration of the period of non-pulsing after each of the pulse of the titanium-containing precursor, the pulse of the nitrogen-containing gas, and the pulse of the silicon-containing gas may be identical. For such an embodiment, a time interval (T₄) of non-pulsing after the pulse of the titanium-containing precursor equals a time interval (T₅) of non-pulsing after the pulse of the nitrogen-containing gas and a time interval (T₆) of non-pulsing after the pulse of the silicon-containing gas. During the time periods of non-pulsing only the constant carrier gas stream is provided to the process chamber.

Alternatively, at least one period of non-pulsing after at least one of the pulse of the titanium-containing precursor, the pulse of the nitrogen-containing gas and the pulse of the silicon-containing gas may have a different duration. That is, the duration of at least one period of non-pulsing after one of the pulses of the titanium-containing precursor, the nitrogen-containing gas, and the silicon-containing may be shorter or longer than another period of non-pulsing. For such an embodiment, a time interval (T₄) of non-pulsing after the pulse of the titanium-containing precursor is different from one of a time interval (T₅) of non-pulsing after the pulse of the nitrogen-containing gas and a time interval (T₆) of non-pulsing after the pulse of the silicon-containing gas. During the time periods of non-pulsing, only the constant carrier gas stream is provided to the process chamber.

Additionally, the time intervals for each pulse of the titanium-containing precursor, the nitrogen-containing gas, the silicon-containing gas and the periods of non-pulsing therebetween for each deposition cycle of the cyclical deposition process may have the same duration. For such an embodiment, a time interval (T₁) for the pulse of the titanium-containing precursor, a time interval (T₂) for the pulse of the nitrogen-containing gas, a time interval (T₃) for the pulse of the silicon-containing gas, a time interval (T₄) of non-pulsing after the pulse of the titanium-containing precursor, a time interval (T₅) of non-pulsing after the pulse of the nitrogen-containing gas and a time interval (T₆) of non-pulsing after the pulse of the silicon-containing gas, each have the same value for each subsequent deposition cycle. For example, in a first deposition cycle (C₁), a time interval (T₁) for the pulse of the titanium-containing precursor has the same duration as the time interval (T₁) for the pulse of the titanium-containing precursor in subsequent deposition cycles (C₂ . . . C_{N}). Similarly, the duration of each pulse of the nitrogen-containing gas, the duration of each pulse of the silicon-containing gas, as well as the duration of the periods of non-pulsing therebetween in the first deposition cycle (C₁) is the same as the duration of each pulse of the nitrogen-containing gas, the duration of each pulse of the silicon-containing gas and the duration of the periods of non-pulsing therebetween in subsequent deposition cycles (C₂ . . . C_{N}), respectively.

Alternatively, the time interval for at least one pulse of the titanium-containing precursor, the nitrogen-containing gas, the silicon-containing gas and the periods of non-pulsing therebetween for one or more deposition cycles of the cyclical deposition process may have different durations. For such an embodiment, one or more of the time intervals (T₁) for the pulses of the titanium-containing precursor, the time intervals (T₂) for the pulses of the nitrogen-containing gas, the time intervals (T₃) for the pulses of the silicon-containing gas, the time intervals (T₄) of non-pulsing after the pulses of the titanium-containing precursor, the time intervals (T₅) of non-pulsing after the pulses of the nitrogen-containing gas and the time intervals (T₆) of non-pulsing and the pulses of the silicon-containing gas may have different values for one or more subsequent deposition cycles of the cyclical deposition process. For example, in a first deposition cycle (C₁), the time interval (T₁) for the pulse of the titanium-containing precursor may be longer or shorter than the time interval (T₁) for the pulse of the titanium-containing precursor in subsequent deposition cycles (C₂ . . . C_{N}). Similarly, the duration of each pulse of the nitrogen-containing gas, the duration of each pulse of the silicon-containing gas and the duration of the periods of non-pulsing therebetween in deposition cycle (C₁) may be different than the duration of corresponding pulses of the nitrogen-containing gas, pulses of the silicon-containing gas and the periods of non-pulsing therebetween in subsequent deposition cycles (C₂ . . . C_{N}), respectively.

The various deposition cycles can be repeated such that the composition of the film can be controlled. For example, repetitive deposition of Ti and N to provide a TiN layer may be formed prior to the introduction of a silicon-containing gas to form TiSiN such that the film may have gradation of composition. Depending upon the cycle times and gases used in each cycle, the film's composition gradation can be varied in an almost unlimited manner. This flexibility provides the ability to tailor the film's characteristics to fit the application.

Referring to step 112, after each deposition cycle (steps 104 through 110) a thickness of the ternary nitride will be formed on the substrate. Depending on specific device requirements, subsequent deposition cycles may be needed to achieve a desired thickness. As such, steps 104 through 110 are repeated until the desired thickness for the titanium silicon nitride (TiSiN) layer is achieved. Thereafter, when the desired thickness for the titanium silicon nitride (TiSiN) layer is achieved the process is stopped as indicated by step 114.

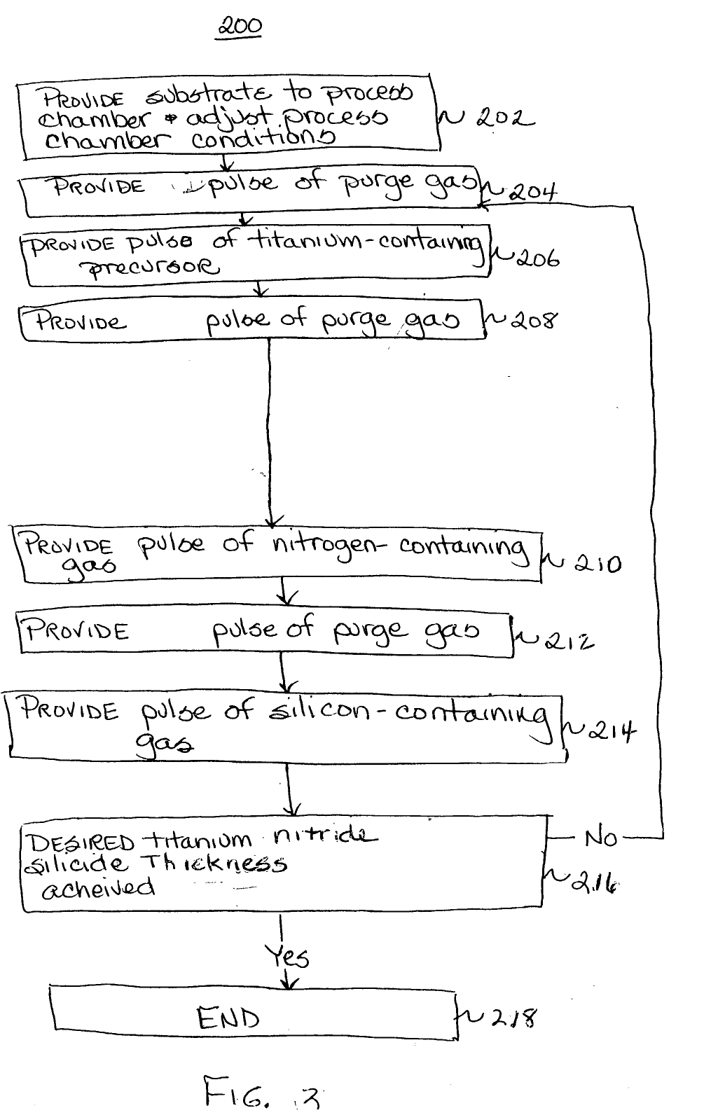

In an alternate process sequence described with respect to FIG. 3, the ternary nitride layer deposition cycle comprises separate pulses for each of the titanium-containing precursor, the nitrogen-containing gas, the silicon-containing gas and a purge gas. For such an embodiment, the titanium silicon nitride (TiSiN) deposition sequence 200 includes providing the substrate to the process chamber and adjusting the process conditions (step 202), providing a pulse of a purge gas to the process chamber (step 204), providing a pulse of a titanium-containing precursor to the process chamber (step 206), providing a pulse of the purge gas to the process chamber (step 208), providing a pulse of a nitrogen-containing gas to the process chamber (step 210), providing a pulse of the purge gas to the process chamber (step 212), providing a pulse of a silicon-containing gas to the process chamber (step 214), and than repeating steps 204 through 214, or stopping the deposition process (step 218) depending on whether a desired thickness for the titanium silicon nitride (TiSiN) layer has been achieved (step 216).

The time intervals for each of the pulses of the titanium-containing precursor, the nitrogen-containing gas, the silicon-containing gas and the purge gas may have the same or different durations as discussed above with respect to FIG. 2. Alternatively, corresponding time intervals for one or more pulses of the titanium-containing precursor, the nitrogen-containing gas, the silicon-containing gas and the purge gas in one or more of the deposition cycles of the titanium silicon nitride (TiSiN) layer deposition process may have different durations.

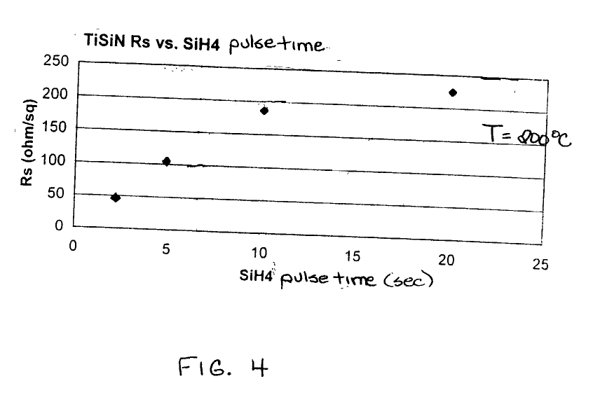

In FIGS. 2-3, the titanium silicon nitride (TiSiN) layer deposition cycle is depicted as beginning with a pulse of the titanium-containing precursor followed by a pulse of a nitrogen-containing gas and a silicon-containing gas. Alternatively, the titanium silicon nitride (TiSiN) layer deposition cycle may start with a pulse of the nitrogen-containing gas, the silicon-containing gas and the titanium-containing precursor in any order, as depicted in FIGS. 4A-4B. Additionally, the titanium silicon nitride (TiSiN) layer deposition cycle may include sequences wherein a pulse of the titanium-containing precursor is followed by a pulse comprising both the nitrogen-containing gas and the silicon containing gas, as depicted in FIG. 4C.

One exemplary process of depositing a titanium silicon nitride (TiSiN) layer comprises alternately providing pulses of tetrakis(dimethylamido)titanium (TDMAT) along with pulses of ammonia (NH₃) and silane (SiH₄). The tetrakis(dimethylamido)titanium (TDMAT) may be provided to an appropriate flow control valve, for example, an electronic flow control valve, at a flow rate of between about 10 sccm (standard cubic centimeters per minute) to about 1000 sccm, and thereafter pulsed for about 0.5 seconds or less. A carrier gas comprising argon (Ar) is provided along with the tetrakis(dimethylamido)titanium (TDMAT) at a flow rate between about 50 sccm to about 1500 sccm. The silane (SiH₄) may be provided to an appropriate flow control valve, for example, an electronic flow control valve, at a flow rate of between about 5 sccm and about 50 sccm, and thereafter pulsed for about 0.3 seconds or less. A carrier gas comprising argon (Ar) is provided along with the silane (SiH₄) at a flow rate of about 10 sccm to about 1000 sccm. The ammonia (NH₃) may be provided to an appropriate flow control valve, for example, an electronic flow control valve, at a flow rate of between about 50 sccm and about 500 sccm, and thereafter pulsed for about 1.0 second or less. A carrier gas comprising argon (Ar) is provided along with the ammonia (NH₃) at a flow rate of about 10 sccm to about 1000 sccm. The substrate may be maintained at a chamber pressure between about 0.1 torr to about 10 torr, at a temperature between about 170° C. to about 250° C. The above-mentioned flow rates for the carrier gas, the tetrakis(dimethylamido)titanium (TDMAT), the ammonia (NH₃) and the silane (SiH₄) may be varied, depending on the volume capacity of the process chamber used.

The deposition rate for the titanium silicon nitride (TiSiN) layer may be variable depending on the silicon-containing gas pulse time. FIG. 4 is a graph of the resistivity for TiSiN plotted as a function of SiH₄ pulse time. For example, at a SiH₄ pulse time of about 20 seconds the resistivity for the TiSiN is about 200 ohms/square, while at a pulse time of about 3 seconds the resistivity for the TiSiN drops to about 50 ohms/square.

Integrated Circuit Fabrication Process Copper Interconnects

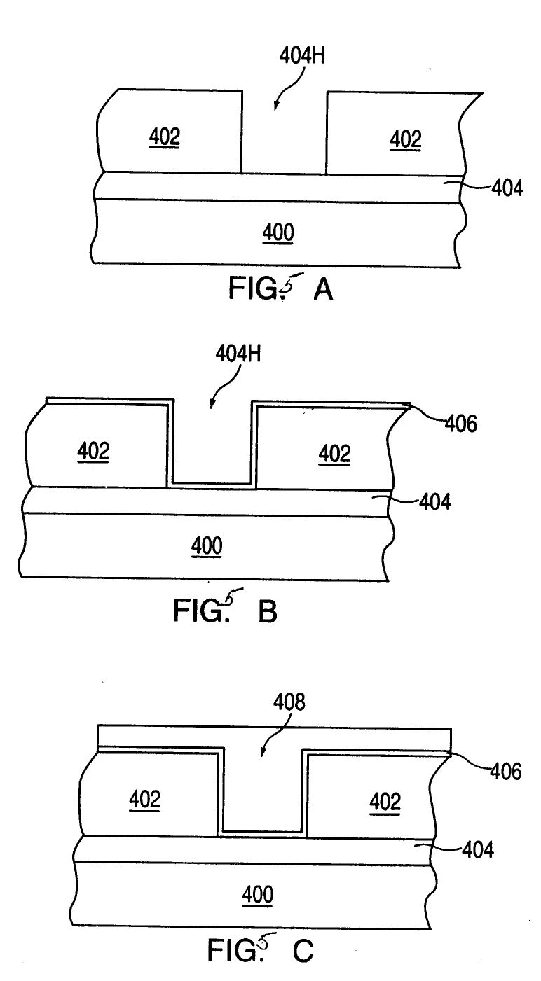

FIGS. 5A-5C illustrate cross-sectional views of a substrate at different stages of a copper interconnect fabrication sequence incorporating the titanium silicon nitride (TiSiN) layer of the present invention. FIG. 5A, for example, illustrates a cross-sectional view of a substrate 400 having metal contacts 404 and a dielectric layer 402 formed thereon.

The substrate 400 may comprise a semiconductor material such as, for example, silicon (Si), germanium (Ge), or gallium arsenide (GaAs). The dielectric layer 402 may comprise an insulating material such as, for example, silicon oxide or silicon nitride. The metal contacts 404 may comprise for example, copper (Cu).

Apertures 404H may be defined in the dielectric layer 402 to provide openings over the metal contacts 404. The apertures 404H may be defined in the dielectric layer 402 using conventional lithography and etching techniques.

Referring to FIG. 5B, a titanium silicon nitride (TiSiN) layer 406 is formed in the apertures 404H defined in the dielectric layer 402. The titanium silicon nitride (TiSiN) layer 406 is formed using the deposition techniques described above with respect to FIGS. 2-8.

The thickness of the titanium silicon nitride (TiSiN) layer 406 is preferably thick enough to form a conformal layer when a porous material such as, for example, silicon oxides (e.g., SiO, SiO₂) is used for the dielectric material. The thickness of the titanium silicon nitride (TiSiN) layer 406 is typically between about 20 Å to about 500 Å.

Thereafter, the apertures 404H are filled with copper (Cu) metallization 408 using a suitable deposition process as shown in FIG. 6C. For example, copper (Cu) may be deposited with a chemical vapor deposition (CVD) process using copper-containing precursors such as Cu⁺²(hfac)₂ (copper hexafluoro acetylacetonate), Cu⁺² (fod)₂ (copper heptafluoro dimethyl octanediene) and Cu⁺¹hfac TMVS (copper hexafluoro acetylacetonate trimethylvinylsilane), among others.

While foregoing is directed to the preferred embodiment of the present invention, other and further embodiments of the invention may be devised without departing from the basic scope thereof, and the scope thereof is determined by the claims that follow.

1. A method of forming a titanium silicon nitride (TiSiN) layer on a substrate, comprising:
providing a substrate; and
forming a titanium silicon nitride (TiSiN) layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor a nitrogen-containing gas and a silicon-containing gas.

2. The method of claim 1 wherein the period of exposure to the titanium-containing precursor, the period of exposure to the nitrogen-containing gas, the period of exposure to the silicon-containing gas, and periods of flow of the inert gas therebetween each have the same duration.

3. The method of claim 1 wherein at least one of the period of exposure to the titanium-containing precursor, the period of exposure to the nitrogen-containing gas, the period of exposure to the silicon-containing gas and periods of flow of the inert gas therebetween has a different duration.

4. The method of claim 1 wherein the period of exposure to the titanium-containing precursor during each deposition cycle of the cyclical deposition process has the same duration.

5. The method of claim 1 wherein at least one period of exposure to the titanium-containing precursor during one or more deposition cycle of the cyclical deposition process has a different duration.

6. The method of claim 1 wherein the period of exposure to the nitrogen-containing gas during each deposition cycle of the cyclical deposition process has the same duration.

7. The method of claim 1 wherein at least one period of exposure to the nitrogen-containing gas during one or more deposition cycle of the cyclical deposition process has a different duration.

8. The method of claim 1 wherein the period of exposure to the silicon-containing gas during each deposition cycle of the cyclical deposition process has the same duration.

9. The method of claim 1 wherein at least one period of exposure to the silicon-containing gas during one or more deposition cycle of the cyclical deposition process has a different duration.

10. The method of claim 1 wherein periods of flow of the inert gas after the period of exposure to the titanium-containing precursor, the period of exposure to the nitrogen-containing gas and the period of exposure to the silicon-containing gas during each deposition cycle of the cyclical deposition process has the same duration.

11. The method of claim 1 wherein at least one period of flow of the inert gas after one of the period of exposure to the titanium-containing precursor, the period of exposure to the nitrogen-containing gas and the period of exposure to the silicon-containing gas during one or more deposition cycle of the cyclical deposition process has a different duration.

12. The method of claim 1 wherein the titanium-containing precursor comprises a compound selected from the group consisting of tetrakis(dimethylamido) titanium (TDMAT) and tetrakis(diethylamido) titanium (TDEAT).

13. The method of claim 1 wherein the silicon-containing gas comprises a compound selected from the group consisting of silane (SiH₄), disilane (Si₂H₆), dichlorosilane (SiH₂Cl₂), silicon tetrachloride (SiCl₄), hexachlorodisilane (Si₂Cl₆), trichlorosilane (SiHCl₃) and methyl silane (SiCH₆).

14. The method of claim 1 wherein the nitrogen-containing gas comprises a compound selected from the group consisting of ammonia (NH₃), hydrazine (N₂H₄), monomethyl hydrazine (CH₃N₂H₃), dimethyl hydrazine (C₂H₆N₂H₂), t-butyl hydrazine (C₄H₉N₂H₃), phenyl hydrazine (C₆H₅N₂H₃), 2,2′-azoisobutane ((CH₃)₆C₂N₂) and ethylazide (C₂H₅N₃).

15. A method of forming a titanium silicon nitride (TiSiN) layer on a substrate, comprising:
providing a substrate; and
forming a titanium silicon nitride (TiSiN) layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor, a nitrogen-containing gas and a silicon-containing gas, and wherein the period of exposure to the titanium-containing precursor, the period of exposure to the nitrogen-containing precursor, the period of exposure to the silicon containing precursor and periods of flow of the inert gas therebetween each have the same duration.

16. The method of claim 15 wherein the period of exposure to the titanium-containing precursor during each deposition cycle of the cyclical deposition process has the same duration.

17. The method of claim 15 wherein at least one period of exposure to the titanium-containing precursor during one or more deposition cycle of the cyclical deposition process has a different duration.

18. The method of claim 15 wherein the period of exposure to the nitrogen-containing gas during each deposition cycle of the cyclical deposition process has the same duration.

19. The method of claim 15 wherein at least one period of exposure to the nitrogen-containing gas during one or more deposition cycle of the cyclical deposition process has a different duration.

20. The method of claim 15 wherein the period of exposure to the silicon-containing gas during each deposition cycle of the cyclical deposition process has the same duration.

21. The method of claim 15 wherein at least one period of exposure to the silicon-containing gas during one or more deposition cycle of the cyclical deposition process has a different duration.

22. The method of claim 15 wherein periods of flow of the inert gas after the period of exposure to the titanium-containing precursor, the period of exposure to the nitrogen-containing gas and the period of exposure to the silicon-containing gas during each deposition cycle of the cyclical deposition process have the same duration.

23. The method of claim 15 wherein at least one period of flow of the inert gas after one of the period of exposure to the titanium-containing precursor, the period of exposure to the nitrogen-containing gas and the period of exposure to the silicon-containing gas during one or more deposition cycle of the cyclical deposition process has a different duration.

24. The method of claim 15 wherein the titanium-containing precursor comprises a compound selected from the group consisting of tetrakis(dimethylamido) titanium (TDMAT) and tetrakis(diethylamido) titanium (TDEAT).

25. The method of claim 15 wherein the silicon-containing gas comprises a compound selected from the group consisting of silane (SiH₄), disilane (Si₂H₆), dichlorosilane (SiH₂Cl₂), silicon tetrachloride (SiCl₄), hexachlorodisilane (Si₂Cl₆), trichlorosilane (SiHCl₃) and methyl silane (SiCH₆).

26. The method of claim 15 wherein the nitrogen-containing gas comprises a compound selected from the group consisting of ammonia (NH₃), hydrazine (N₂H₄), monomethyl hydrazine (CH₃N₂H₃), dimethyl hydrazine (C₂H₆N₂H₂), t-butyl hydrazine (C₄H₉N₂H₃), phenyl hydrazine (C₆H₅N₂H₃), 2,2′-azoisobutane ((CH₃)₆C₂N₂) and ethylazide (C₂H₅N₃).

27. A method of forming a titanium silicon nitride (TiSiN) layer on a substrate, comprising:
providing a substrate; and
forming a titanium silicon nitride (TiSiN) layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor, a nitrogen-containing gas and a silicon-containing gas, and wherein at least one period of exposure to the titanium-containing precursor, the period of exposure to the nitrogen-containing gas, the period of exposure to the silicon containing gas and periods of flow of the inert gas therebetween has a different duration.

28. The method of claim 27 wherein the period of exposure to the titanium-containing precursor during each deposition cycle of the cyclical deposition process has the same duration.

29. The method of claim 27 wherein at least one period of exposure to the titanium-containing precursor during one or more deposition cycle of the cyclical deposition process has a different duration.

30. The method of claim 27 wherein the period of exposure to the nitrogen-containing gas during each deposition cycle of the cyclical deposition process has the same duration.

31. The method of claim 27 wherein at least one period of exposure to the nitrogen-containing gas during one or more deposition cycle of the cyclical deposition process has a different duration.

32. The method of claim 27 wherein the period of exposure to the silicon-containing gas during each deposition cycle of the cyclical deposition process has the same duration.

33. The method of claim 27 wherein at least one period of exposure to the silicon-containing gas during one or more deposition cycle of the cyclical deposition process has a different duration.

34. The method of claim 27 wherein periods of flow of the inert gas after the period of exposure to the titanium-containing precursor, the period of exposure to the nitrogen-containing gas and the period of exposure to the silicon-containing gas during each deposition cycle of the cyclical deposition process have the same duration.

35. The method of claim 27 wherein at least one period of flow of the inert gas after one of the period of exposure to the titanium-containing precursor, the period of exposure to the nitrogen-containing gas and the period of exposure to the silicon-containing gas during one or more deposition cycle of the cyclical deposition process has a different duration.

36. The method of claim 27 wherein the titanium-containing precursor comprises a compound selected from the group consisting titanium tetrachloride (TiCl₄), tetrakis(dimethylamido) titanium (TDMAT) and tetrakis(diethylamido) titanium (TDEAT).

37. The method of claim 27 wherein the silicon-containing gas comprises a compound selected from the group consisting of silane (SiH₄), disilane (Si₂H₆), dichlorosilane (SiH₂Cl₂), silicon tetrachloride (SiCl₄), hexachlorodisilane (Si₂Cl₆), trichlorosilane (SiHCl₃) and methyl silane (SiCH₆).

38. The method of claim 27 wherein the nitrogen-containing gas comprises a compound selected from the group consisting of ammonia (NH₃), hydrazine (N₂H₄), monomethyl hydrazine (CH₃N₂H₃), dimethyl hydrazine (C₂H₆N₂H₂), t-butyl hydrazine (C₄H₉N₂H₃), phenyl hydrazine (C₆H₅N₂H₃), 2,2′-azoisobutane ((CH₃)₆C₂N₂) and ethylazide (C₂H₅N₃).

39. A method of forming a titanium silicon nitride (TiSiN) layer on a substrate, comprising:
providing a substrate; and
forming a titanium tantalum silicon nitride (TiSiN) layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor, a nitrogen-containing gas and a silicon-containing gas, wherein the period of exposure to the titanium-containing precursor, the period of exposure to the nitrogen-containing gas, the period of exposure to the silicon containing gas and periods of flow of the inert gas therebetween each have the same duration, and wherein the period of exposure to the titanium-containing precursor, the period of exposure to the nitrogen-containing gas, the period of exposure to the silicon containing gas and periods of flow of the inert gas therebetween have the same duration during each deposition cycle of the cyclical deposition process.

40. A method of forming a titanium silicon nitride (TiSiN) layer on a substrate, comprising:
providing a substrate; and
forming a titanium silicon nitride (TiSiN) layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor, a nitrogen-containing gas and a silicon-containing gas, wherein the period of exposure to the titanium-containing precursor, the period of exposure to the nitrogen-containing gas, the period of exposure to the silicon containing gas and periods of flow of the inert gas therebetween each have the same duration, and wherein at least one of the period of exposure to the titanium-containing precursor, the period of exposure to the nitrogen-containing gas, the period of exposure to the silicon containing gas and periods of flow of the inert gas therebetween has a different duration during one or more deposition cycle of the cyclical deposition process.

41. A method of forming a titanium silicon nitride (TiSiN) layer on a substrate, comprising:
providing a substrate; and
forming a titanium silicon nitride (TiSiN) layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor, a nitrogen-containing gas and a silicon-containing gas, wherein at least one of the period of exposure to the titanium-containing precursor, the period of exposure to the nitrogen-containing gas, the period of exposure to the silicon containing gas and periods of flow of the inert gas therebetween has a different duration, and wherein the period of exposure to the titanium-containing precursor, the period of exposure to the nitrogen-containing gas, the period of exposure to the silicon containing gas and periods of flow of the inert gas therebetween have the same duration during each deposition cycle of the cyclical deposition process.

42. A method of forming a titanium silicon nitride (TiSiN) layer on a substrate, comprising:
providing a substrate; and
forming a titanium silicon nitride (TiSiN) layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor, a nitrogen-containing gas and a silicon-containing gas, wherein at least one of the period of exposure to the titanium-containing precursor, the period of exposure to the nitrogen-containing gas, the period of exposure to the silicon containing gas and periods of flow of the inert gas therebetween has a different duration, and wherein at least one of the period of exposure to the titanium-containing precursor, the period of exposure to the nitrogen-containing gas, the period of exposure to the silicon containing gas and periods of flow of the inert gas therebetween has a different duration during one or more deposition cycle of the cyclical deposition process.

43. A method of forming a titanium silicon nitride (TiSiN) barrier layer for a copper interconnect, comprising:
providing a substrate;
forming a titanium silicon nitride (TiSiN) barrier layer on the substrate using a cyclical deposition process comprising a plurality of cycles, wherein each cycle comprises establishing a flow of an inert gas to a process chamber and modulating the flow of the inert gas with an alternating period of exposure to one of either a titanium-containing precursor, a nitrogen-containing gas and a silicon-containing gas; and
depositing copper on the titanium silicon nitride (TiSiN) barrier layer.

44. The method of claim 43 wherein the period of exposure to the titanium-containing precursor, the period of exposure to the nitrogen-containing gas, the period of exposure to the silicon-containing gas, and periods of flow of the inert gas therebetween each have the same duration.

45. The method of claim 43 wherein at least one of the period of exposure to the titanium-containing precursor, the period of exposure to the nitrogen-containing gas, the period of exposure to the silicon-containing gas and periods of flow of the inert gas therebetween has a different duration.

46. The method of claim 43 wherein the period of exposure to the titanium-containing precursor during each deposition cycle of the cyclical deposition process has the same duration.

47. The method of claim 43 wherein at least one period of exposure to the titanium-containing precursor during one or more deposition cycle of the cyclical deposition process has a different duration.

48. The method of claim 43 wherein the period of exposure to the nitrogen-containing gas during each deposition cycle of the cyclical deposition process has the same duration.

49. The method of claim 43 wherein at least one period of exposure to the nitrogen-containing gas during one or more deposition cycle of the cyclical deposition process has a different duration.

50. The method of claim 43 wherein the period of exposure to the silicon-containing gas during each deposition cycle of the cyclical deposition process has the same duration.

51. The method of claim 43 wherein at least one period of exposure to the silicon-containing gas during one or more deposition cycle of the cyclical deposition process has a different duration.

52. The method of claim 43 wherein periods of flow of the inert gas after the period of exposure to the titanium-containing precursor, the period of exposure to the nitrogen-containing gas and the period of exposure to the silicon-containing gas during each deposition cycle of the cyclical deposition process has the same duration.

53. The method of claim 43 wherein at least one period of flow of the inert gas after one of the period of exposure to the titanium-containing precursor, the period of exposure to the nitrogen-containing gas and the period of exposure to the silicon-containing gas during one or more deposition cycle of the cyclical deposition process has a different duration.

54. The method of claim 43 wherein the titanium-containing precursor comprises a compound selected from the group consisting of titanium tetrachloride (TiCl₄), tetrakis(dimethylamido) titanium (TDMAT) and tetrakis(diethylamido) titanium (TDEAT).

55. The method of claim 43 wherein the silicon-containing gas comprises a compound selected from the group consisting of silane (SiH₄), disilane (Si₂H₆), dichlorosilane (SiH₂Cl₂), silicon tetrachloride (SiCl₄), hexachlorodisilane (Si₂Cl₆), trichlorosilane (SiHCl₃) and methyl silane (SiCH₆).

56. The method of claim 43 wherein the nitrogen-containing gas comprises a compound selected from the group consisting of ammonia (NH₃), hydrazine (N₂H₄), monomethyl hydrazine (CH₃N₂H₃), dimethyl hydrazine (C₂H₆N₂H₂), t-butyl hydrazine (C₄H₉N₂H₃), phenyl hydrazine (C₆H₅N₂H₃), 2,2′-azoisobutane ((CH₃)₆C₂N₂) and ethylazide (C₂H₅N₃).

57. A copper interconnect, formed by a method comprising:
forming a titanium silicon nitride (TiSiN) barrier layer in one or more apertures formed on a substrate, wherein the titanium silicon nitride (TiSiN) barrier layer is formed by alternately adsorbing a titanium-containing precursor, a silicon-containing gas and a nitrogen-containing gas on the substrate; and
depositing copper on the titanium silicon nitride (TiSiN) barrier layer.

58. The copper interconnect of claim 55 wherein the titanium-containing precursor comprises a compound selected from the group consisting of titanium tetrachloride (TiCl₄), tetrakis(dimethylamido)titanium (TDMAT) and tetrakis(diethylamido)titanium (TDEAT).

59. The copper interconnect of claim 55 wherein the silicon-containing gas comprises a compound selected from the group consisting of silane (SiH₄), disilane (Si₂H₆), dichlorosilane (SiH₂Cl₂), silicon tetrachloride (SiCl₄), hexachlorodisilane (Si₂Cl₆), trichlorosilane (SiHCl₃) and methyl silane (SiCH₆).

60. The copper interconnect of claim 55 wherein the nitrogen-containing gas comprises a compound selected from the group consisting of ammonia (NH₃), hydrazine (N₂H₄), monomethyl hydrazine (CH₃N₂H₃), dimethyl hydrazine (C₂H₆N₂H₂), t-butyl hydrazine (C₄H₉N₂H₃), phenyl hydrazine (C₆H₅N₂H₃), 2,2′-azoisobutane ((CH₃)₆C₂N₂) and ethylazide (C₂H₅N₃).
